(19) United States
(12) Patent Application Publication
(10) Pub. No.: US 2024/0227156 A1
(43) Pub. Date: Jul. 11, 2024

(54) TOOLBOX BAR ATTACHMENT FOR ATTACHING ACCESSORIES

(71) Applicants: Michael H. Panosian, Irvine, CA (US); Joshua M. Keeler, Irvine, CA (US)

(72) Inventors: Michael H. Panosian, Irvine, CA (US); Joshua M. Keeler, Irvine, CA (US)

(21) Appl. No.: 18/094,409

(22) Filed: Jan. 9, 2023

(51) Int. Cl. B25H 3/02

(52) U.S. Cl. CPC B25H 3/02

(57) ABSTRACT

A method and system are disclosed including a hang bar, usable with a support surface such as a sidewall of a toolbox, the hang bar having one or more hang clips with an aperture that closely matches the shape and size of the cross section of the hang bar, configured to nestably mount the hang clips over the hang bar, providing a clip hook protruding from the hang clip to allow mounting an item on the clip hook.

### CROSS-REFERENCE(S) TO RELATED APPLICATION(S)

None.

### TECHNICAL FIELD

This application relates generally to attachment apparatuses. More specifically, this application relates to hang clips mounted on a hang bar attached to a support surface, such as a side of a receptacle or toolbox.

### BRIEF DESCRIPTION OF THE DRAWINGS

The drawings, when considered in connection with the following description, are presented for the purpose of facilitating an understanding of the subject matter sought to be protected.

FIG. 1A shows an example toolbox in an embodiment showing a perspective, exploded view of a hang bar prior to attachment of the hang bar to the toolbox;

FIG. 1B shows examples of various hang bar profiles;

FIG. 2 shows an example toolbox in another embodiment showing a perspective, exploded view of a hang bar prior to attachment of the hang bar to the toolbox;

FIG. 3 shows an enlarged perspective view of a hang bar attached to a toolbox;

FIG. 4A shows a perspective view of the hang bar attached to the toolbox with a clip hook;

FIG. 4B shows a perspective view of another embodiment of a hang bar attached to a toolbox with a clip hook; and

FIG. 5 shows an example exploded perspective view of a clip hook of the present invention attached to a hang bar of a toolbox.

### DETAILED DESCRIPTION

While the present disclosure is described with reference to several illustrative embodiments and example devices described herein, it should be clear that the present disclosure should not be limited to such embodiments. Therefore, the description of the embodiments provided herein is illustrative of the present disclosure and should not limit the scope of the disclosure as claimed. In addition, while following description references particular configurations of toolbox and hang bar, it will be appreciated that the hang bar may have various shapes in cross section and be used with other containers such as closets, cabinets, and the like. Also, although a toolbox is described in the present disclosure, the hang bar may be attached to various other support surfaces, such as walls, cabinet doors or sides, various types of receptacles, or other types of support surfaces, such as a cooler walls, a tool bucket (where the hang bar can be curved to complementarily match the curvature of the bucket), temporarily attached to a structure during construction (e.g., to the exposed studs of a wall, or the like), to a workbench, and so on.

Briefly described, a method and system are disclosed including a hang bar, usable with a support surface such as a sidewall of a toolbox, the hang bar having one or more hang clips with an aperture that closely matches the shape and size of the cross section of the hang bar, configured to nestably mount the hang clips over the hang bar, providing a clip hook protruding from the hang clip to allow mounting an item on the clip hook. In some embodiments, the hang bar may be adjustable by tilting or moving it in and out (or towards or away from) with respect to the toolbox using slotted attachment points, as further described below. The hang bar is further designed to match the aperture of the hang clip in cross section. In some embodiments, the hang bar has two side arms that are attached to the hang bar at an angle which is less than 90 degrees. The two side arms are designed to attach to an angled corner surface of the toolbox, matching the angle of the side arms. While in other embodiments, the side arms are at a right angle with respect to the hang bar and are adjustably attached to sidewalls of the toolbox. In these embodiments, the distance and angle of the hang bar may be user-adjusted with respect to the toolbox. In still other embodiments, the hang bar may have different configurations and be attached using various techniques as further described below.

In various embodiments, a hanging apparatus is disclosed including a hang bar having a hanging zone to mount a hang clip, and a mounting zone having mounting apparatus deployed thereon to mount the hang bar to a support surface. It is further useable with a hang clip to mount on the hanging section in which a cross section of the hanging section of the hang bar is matched with a cross section of an aperture of the hang clip to securely mount the hang clip on the hanging zone. In some embodiments, a pair of hang bar arms to attach to a side wall of the toolbox, each hang bar arm having a hole or a slot for receiving a fastener to adjustably mount the hang bar to the toolbox. A cross section of the hang bar is matched with a cross section of a cavity in a hang clip to securely mount the hang clip on the hang bar.

In various embodiments, toolbox with external storage is disclosed including a vertically oriented wall of the toolbox, a hang bar having a mounting zone and hanging zone, in which the hanging zone is useable to couple with a hang clip, the hang clip having an aperture with a cross section that matches a cross section of the hang bar, in which the hang clip allows externally hanging tools and other objects from the toolbox.

A method of mounting an item on a support surface is disclosed including mounting a hang clip onto a hang bar having a first cross sectional area, the hang clip having an aperture and a clip hook protruding from the hang clip, wherein the aperture has a second cross sectional area that is matched to the first cross sectional area with respect to size and shape, and mounting an item on the clip hook.

In an embodiment, a first slot is formed in the hang bar arm for receiving a first fastener protruding from the vertical side wall of the toolbox. In another embodiment, a second slot formed in the hang bar arm for receiving a second fastener protruding from the vertical side wall of the toolbox. In an embodiment, the first slot provides primarily for horizontal movement of the hang bar with respect to the toolbox and the second slot provides primarily for angular movement of the hang bar with respect to the toolbox.

In another embodiment, the clip hook includes an aperture having a first cross-sectional shape corresponding to a second cross sectional shape of the toolbox hang bar. And wherein the first and second shape are rectangles. And wherein the first cross-sectional shape has a width W1 and the second cross sectional shape has width W2, and W2 is greater than W1 by a small amount, such as about 1 mm.

In an embodiment, the first cross sectional shape comprises one of a J shape, a U shape, a square shape, a circular shape and a conical shape. In another embodiment, the toolbox includes a fastening corner strip. In an embodiment, the toolbox includes a vertically slidable rear hang bar. In a further embodiment the toolbox includes a pair of wheels for rolling the toolbox.

Building contractors, construction crews, carpet layers, private do-it-yourself (DIY) people, shipping operations and warehouses that use toolboxes, often have loose items that need quick access. For example, boxes of fasteners typically have holes in the top of the packaging for hanging the boxes in the store. Making use of such hanging holes in the field is beneficial, so that the fasteners may be quickly accessed and used on the job. Thus, it is advantageous to provide a means for hanging items from a toolbox and allowing for adjustability of such hanging means.

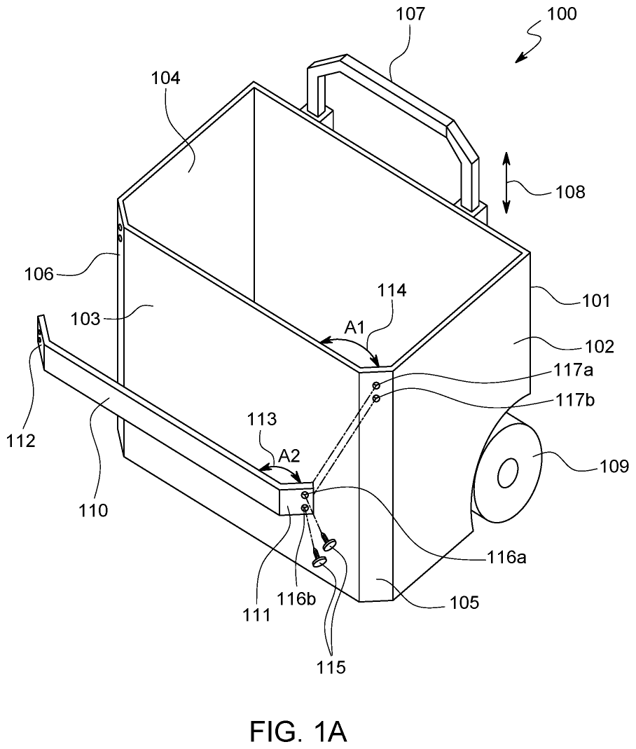

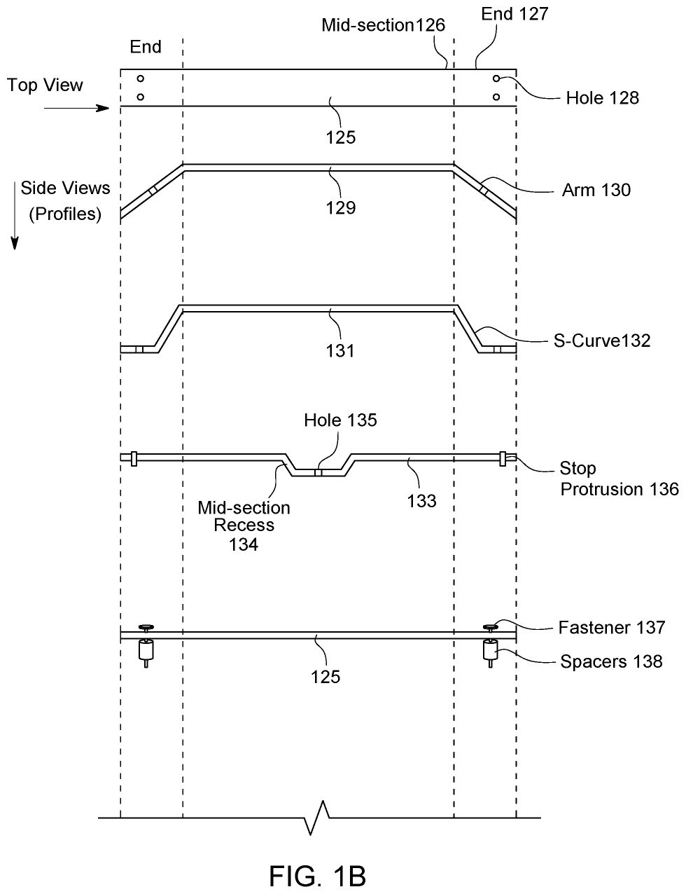

The present disclosure may be understood with respect to FIGS. 1-5, described in further details below. It is to be noted that directions, orientations, and other relative terms such as “front”, “back”, “top”, “bottom”, “left”, “right”, “inside”, “outside”, “interior”, “exterior”, “downward”, “upward”, “front-facing”, “down-facing”, “vertical”, “horizontal”, “diagonal”, and the like are described with respect or relative to a distinguishing feature of the device body itself. For example, if the front part or surface of a system body or an object is identified in the description, then rear or back is defined as the part or surface opposite the front surface, left is defined as the left side when looking into the front surface, and so on. As long as directions are unambiguously identifiable based on the descriptions and figures, how the orientations are defined is immaterial.

FIG. 1A shows an example toolbox in an embodiment showing a perspective, exploded view of a hang bar prior to attachment of the hang bar to the toolbox. In various embodiments, toolbox 100 includes a toolbox rear wall 101, a toolbox vertical side wall 102, a vertical front wall 103 and a vertical side wall 104. The toolbox includes a right corner strip 105 (or sidewall), shaped like a vertically oriented bevel, on a right side and a left corner strip 106 on a left side of the toolbox 100. In an embodiment, the toolbox 100 includes a rear handle 107 that moves vertically in direction of arrowheads 108 to extend and retract the handle 107. The toolbox includes rear wheel 109. The toolbox may include a hang bar 110 having a pair of hang bar arms 111, 112 integrated with the hang bar 110 (for example, the two ends of the hang bar 110 may be bent at an angle to create the hang bar arms) to attach to side walls 102, 104 of the toolbox 100. In various embodiments, the corner strip 105 is formed at an angle 114 or A1, such as at 45 degrees with respect to front wall 103 or vertical side wall 104. The hang bar arms 111 and 112 may be an integral part of the hang bar 110 bent to form the arms. The hang bar arms 111 and 112 may be formed at corresponding angles A2 or 113 or at different angles, if the toolbox 100 is asymmetrical with respect to a vertical centerline of the vertical front wall 103. In another embodiment, the angles A1 and A2 may be substantially equal and range from 0 to 90 degrees or greater. The hang bar 110 is secured to the toolbox 100 using fasteners 115, such as screws secured into openings 116a and 116b of the hang bar 110 and then into holes 117a and 117b of the toolbox 100.

It will be appreciated that vertically oriented as used herein indicates walls (for example, front wall 103 or side wall 104) of the toolbar that are substantially vertical with respect to a lid, a top or a bottom surface of the toolbox without necessarily being exactly perpendicular to the toolbox lid or bottom surface. For example, the side walls of the toolbox may have a slight angle (about less than 15 degrees) away from perpendicular with respect to the top or bottom surfaces of the toolbox.

In various embodiments, toolbox 100 is used to carry hand tools, power tools, tape measures, and other technical work-related instruments. Often, the internal volume of a toolbox 100 may not be sufficient to carry all the tools needed for a job. The hang bar 110 allows hanging various pouches and tools that need to be quickly accessible without increasing the size of the toolbox 100. This way, the toolbox 100 provides external storage without increasing the physical size or dimensions of the toolbox 100. Handle 107, in conjunction with the wheels 109 may be used to more easily carry the toolbox 100 without lifting it off the ground. In various embodiments, several hang bars similar to hang bar 110 may be installed around the perimeter of the toolbox 100, such as the sides and the back panels to increase the carrying capacity of the toolbox 100. Angles of the hang bar arms 111 and 112 relative to the middle section of the hang bar 110 may be the same or different, depending on the geometry of the toolbox 100. For example, if the toolbox is asymmetrical with left side being wider than the right side, or if the sides are constructed at an angle, then fastening the hang bar to the toolbox may be done at different angles. Still in other embodiments, the attachment angles of bar arms 111 and 112 with respect to middle section of the hang bar 110 may be at 90 degrees.

In various embodiments, the fasteners 115 may be screws, nuts and bolts, rivets, or other similar implements to firmly attach the hang bar 110 to the toolbox sidewalls or corner strips 105 and 106. In some embodiments, the fasteners 115 are user-adjustable to adjust the distance and orientation of the hang bar 110, while in other embodiments, the fasteners 115 are factory-fixed and are not alterable by the end user without damaging the toolbox 100 or parts of the toolbox 100.

FIG. 1B shows examples of various hang bar profiles. In various embodiments, and as described herein, a hang bar may have various shapes and configurations. Each hang bar may have different sections including a mid-section 126 and end sections 127. The hang bar also includes a mounting zone, which has holes, slots, studs, screws, nuts, rivets, weld, magnets, glues, or a combination of these methods, or other attachment apparatus used for attaching the hang bar to the support surface. The mounting zone of the hang bar may be anywhere along the length of the hang bar including the ends or somewhere in the mid-section, not necessarily the center of the mid-section. Portions of the hang bar that are not part of the mounting zone form a hanging zone on which hang clips may be mounted. These configurations, shown in top view and side views or profiles, include a straight flat hang bar 125 having one or more holes 128 in each end, a hang bar 129 with arms 130 at the ends, a hang bar 131 with S-curves 132 at the end sections 127, a hang bar 133 with a mid-section recess 134 having a hole 135 and stops 136, and the flat hang bar 125 that is attached to a flat surface with fasteners 137 and spacers 138.

In various embodiments, the flat hang bar 125 may be attached to a support surface in several ways. It may be attached to a flat support surface with a recessed portion that creates a gap between the hang bar 125 (shown in top view and side view) and the recessed portion to accommodate the mounting of a hang clip. Another way of attaching the hang bar 125 is using spacers 138 between the mounting zone of the hang bar 125 to create a gap to allow mounting of a hang clip. The spacers 138 may be used by passing fasteners 137, such as screws, to attach the hang bar 125 to the support surface.

In various embodiments, the hang bar 129 (shown in side view) with arms on both ends of the hang bar 129 is described in detail with respect to FIGS. 1A and 2-4.

In various embodiments, the hang bar 131 (shown in side view) may be bent towards the end sections 127 to create S-curves 132, as shown in FIG. 1B. The S-curves create end sections that are parallel with the mid-section of the hang bar 131 but with an offset, thus, creating a gap between the hang bar 131 and the mounting surface to allow mounting the hang clips.

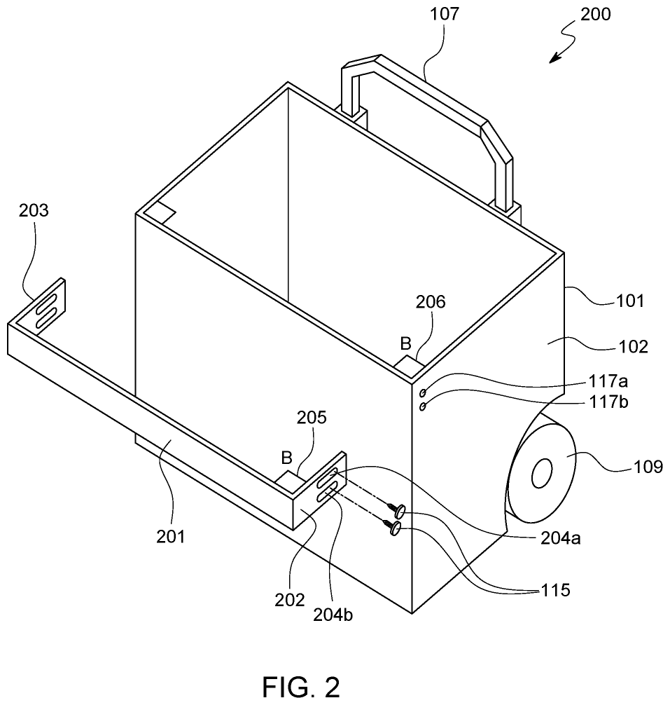

In various embodiments, the hang bar 133 (shown in side view) may have a mounting zone at a mid-section recess 134 with a hole 135 (or other mounting apparatus) to attach the hang bar 133 to the support surface. The mid-section recess 134 is offset from the rest of the hang bar 133, thus creating a gap for mounting the hang clips. The stop protrusions 136 may be studs or other obstruction that prevent the hang clips to slide off the hang bar once mounted. This configuration may be useful for attachment of the hang bar 133 on a narrow support surface such as a column, where the two ends cannot be mounted. FIG. 2 shows an example toolbox in another embodiment showing a perspective, exploded view of a hang bar prior to attachment of the hang bar to the toolbox. In some embodiments, toolbox 200 incudes a hang bar 201 with hang bar arms 202, 203 each having an upper slot 204a and a lower slot 204b for receiving a fastener 115 to adjustably mount the handle/hang bar 201 to the toolbox 200. A substantially right angle B 206 is formed by each corner of the toolbox 200 to correspond to the hang bar right angle 205 at each corner of the hang bar 201. Toolbox 200 further includes holes 117a and 117b, corresponding to slots 204a and 204b, respectively, in the side wall 102.

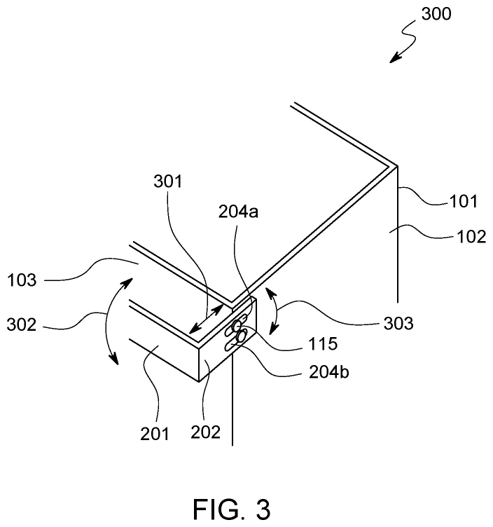

In various embodiments, the hang bar 201 may be adjusted with respect to the toolbox 200 to allow more or less gap between the toolbox 200 and the hang bar 201. The angle of the hang bar 201 with respect toolbox 200 may also be adjusted to allow more convenient access by a user at different angles and also accommodate bigger or different shaped power tools hanging from hang bar 201. The operation of the hang bar 201 is described in more detail with respect to FIG. 3 below.

In various embodiments, fastening slots may be deployed within the bar arms, such as upper and lower slots 204a and 204b, respectively, and the corresponding holes 117a and 117b be deployed withing the sidewall 102. In other embodiments, the slots may be deployed within the sidewall 102 and the holes may be made within the bar arms. Still in other embodiments, slots may be deployed within both the sidewall and the bar arms.

In various embodiments, the fastening slots may be deployed within the sidewall 102 in a vertical orientation to allow adjusting the hanging height of the hang bar 201 with respect to the toolbox.

FIG. 3 shows an enlarged perspective view of a hang bar attached to a toolbox. In various embodiments, hang bar perspective view 300 shows toolbox back wall 101, side wall 102, front wall 103, hang bar 201, hang bar arm 202, lower slots 204a, upper slots 204b, and fasteners 115. The hang bar 201 may horizontally slide in and out with respect to toolbox 200 front wall 103, as signified by arrow 301, and also tilt up and down as signified by arrow 302. Upper slot 204a and lower slot 204b slide in and out in opposite directions 303 to allow the tilting of hang bar 201.

In various embodiments, the hang bar 201 is movable in horizontal direction of arrows 301 and in an angular (pivotal) direction of arrows 302 and 303. In an embodiment, upper slot 204a allows primarily for the horizontal movement of the hang bar 201 with respect to the side wall 102 toolbox, as shown by arrow 301. In an embodiment, lower slot 204b allows primarily for angular movement 302, 303 with respect to the toolbox 200. As can be seen from the figure, when upper slot 204a slides inwards (towards back panel 101) and lower slot 204b slides outwards, hang bar 201 tilts upwards, and vice versa.

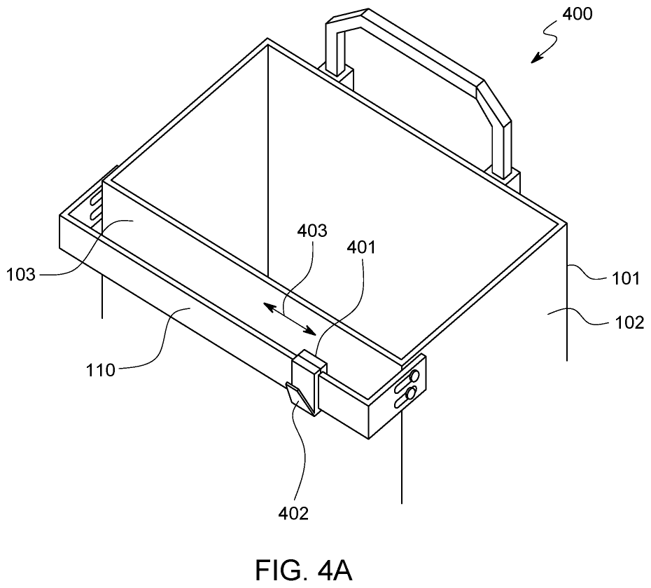

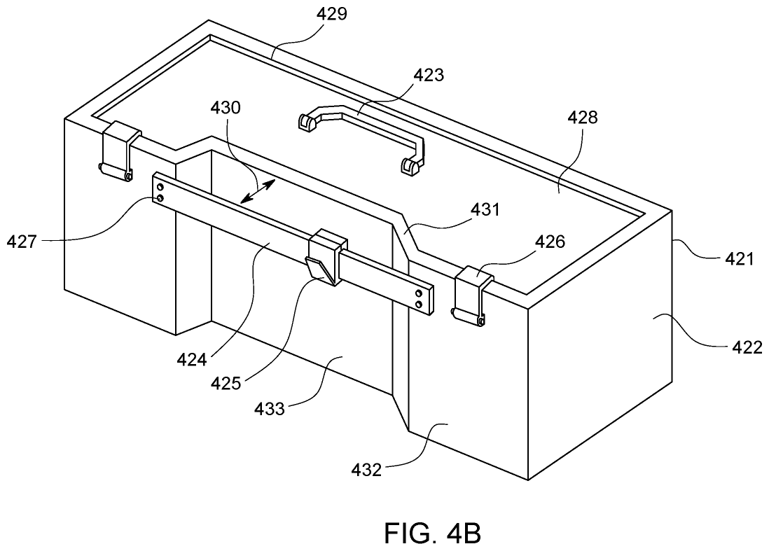

FIG. 4A shows a perspective view of the hang bar 110 attached to the toolbox with a clip hook of the present invention. In various embodiments, the clip hook configuration 400 includes the toolbox 200 with back wall 101, side wall 102, and front wall 103. It further includes one or more hang clips 401 mounted on the hang bar 110, a clip hook 402 on the hang clip 401 for receiving an item fashioned for hanging on the clip hook 402. The hang clip 401 may slide along the length of the hang bar 110 as shown by arrow 403.

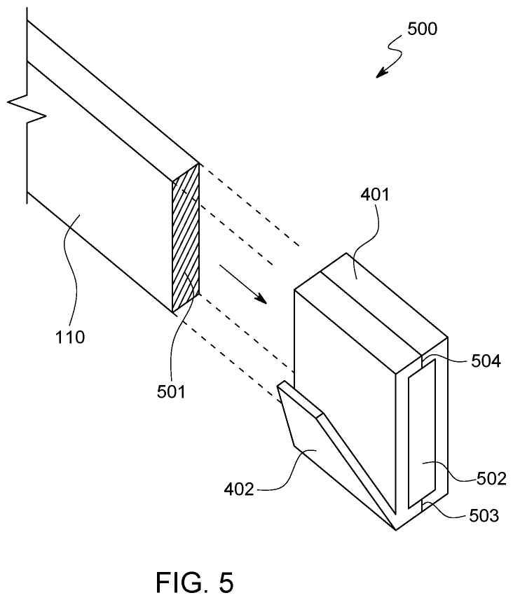

In various embodiments, the hang clip 401 may have a rectangular aperture for nestably mounting on a rectangular (in cross section) shaped hang bar, by passing the hang bar 110 through the aperture. The hang bar is mounted in a manner that allows for angular and horizontal movement of the hang bar with respect to the vertical side wall 102, 104 of the toolbox 100. The hang clip 401 includes an aperture having a first cross-sectional shape corresponding to a second cross sectional shape (e.g., a rectangle) of the toolbox hang bar 110. In an embodiment, the first cross sectional shape has a width W1 and the second cross sectional shape has width W2, and W2 is greater than W1 by a small gap, such as about 1 mm, so that the hang bar 110 may be partially or completely enclosed within the aperture of the hang clip 401, as further described below with respect to FIG. 5. In an embodiment, first cross sectional shape comprises one of a J shape, a U shape, a rectangle shape, a square shape, a circular shape or a triangular shape. The embodiment depicted in FIG. 4A shows that hang clip 401 moves slidably along the hang bar 110 in a horizontal direction 403. While only one hang clip 401 is shown, there may be multiple hang clips 401 mounted on the hang bar 110. Each clip hook 402 may be modified to have multiple shapes mounted thereon. The clip hook 402 may have the shape of a finger, J shape, U shape, S shape or other hook shape.

FIG. 4B shows a perspective view of another embodiment of a hang bar attached to a toolbox with a clip hook. In various embodiments, toolbox 421 includes a side wall 422, a handle 423, a hang bar 424 attached to toolbox 421, a hang clip 425 mounted on the hang bar 424, locking latches 426, fasteners 427 to attach hang bar 424 to toolbox 421, toolbox lid 428, lid hinges 429, a gap 430 between the hang bar 424 and toolbox 421 to provide clearance for mounting hang clip 425, a bend 431 in a front wall 432 to create a recessed wall 433.

In various embodiments, any one of the vertically oriented sidewalls of the toolbox 421 may be adapted and used to attach the hang bar 424. The hang bar 424 may be straight, without any side sections or arms, while in other embodiments, it may have S-curves on its two ends (not shown in this figure; two 90 degree turns resulting in the ends of the hang bar 424 standing off from but being parallel to its middle section) to create a gap between the hang bar 424 and the sidewall on which it is mounted. In still other embodiments, a flat hang bar 424 may be employed and attached to the front wall 432, beyond the boundaries and across the recessed wall 433. The gap 430 may be created by using spacers or stand-offs between hang bar 424 and front wall 432, through which spacers the fasteners 427 pass.

In various embodiments, one or more hang bars 424 may be attached to the front wall 432, side walls 422, or back wall (opposite from front wall 432) of the toolbox 421, some them or all of them.

FIG. 5 shows an example exploded perspective view of a clip hook of the present invention attached to a hang bar of a toolbox. The example perspective view includes clip hook 401 with clip hook 402 and passage or channel or aperture 502 having an example rectangular shape for receiving a corresponding rectangular-shaped cross-section 501 of hang bar 110. Clamp seams 503 and 504 close around the hang bar 110 to partially or completely enclose the hang bar 110.

In various embodiments, the hang clip 401 may take various shapes and have various cross-sectional shapes, such as rectangular, circular, oval, trapezoidal, or any other regular or irregular shape that closely matches at least a portion of the cross-section 501 of the hang bar 110, such that the hanging clip 401 resists rotation about the hang bar 110 yet permits sliding therealong.

In various embodiments, there may be one or two clamp seams 503 and 504 that allows the clip hook 401 to open the aperture 502 within the clip hook 401 to embrace and enclose hang bar 110 partially or entirely.

In various embodiments, the hook 402 may take various shapes, such as an edge, a curved hook like a fishing hook, a ring, or other implements that allow hanging objects from it. In other embodiments, the hook 402 may be replaced by a hole or aperture, distinct from aperture 502, so that a hook deployed on the tools or pouches to be hung from the hang bar 110 can engage the hole.

In various embodiments, a method is provided for mounting an item on a hang clip of a hang bar. The method includes providing a first hang clip having an aperture, nestably mounting the hang clip over a hang bar, providing a clip hook protruding from the hang clip and mounting an item on the clip hook. The hang bar is mounted on a toolbox and angularly adjusting the hang bar with respect to the toolbox. Multiple hang clips are mounted to the hang bar.

It will be understood that unless explicitly stated or specified, the steps described in a process are not ordered and may not necessarily be performed or occur in the order described or depicted. For example, a step A in a process described prior to a step B in the same process, may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” It is further understood that any phrase of the form “A/B” shall mean any one of “A”, “B”, “A or B”, or “A and B”. This construct includes the phrase “and/or” itself.

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

1. A hanging apparatus comprising:
a hang bar having a hanging zone to mount a hang clip, and a mounting zone having mounting apparatus deployed thereon to mount the hang bar on a support surface; wherein
a cross section of the hanging section of the hang bar is matched with a cross section of an aperture of the hang clip to securely mount the hang clip on the hanging section.

2. The hanging apparatus of claim 1, wherein the hang baris one of a flat hang bar, a hang bar with bent arms, a hang bar with S-curves, and hang bar with a mid-section recess.

3. The hanging apparatus of claim 1, further comprising a seam in the hang clip to allow mounting the hang clip onto the mounting zone of the hang bar.

4. The hanging apparatus of claim 2, further comprising a stop protrusion to prevent the hang clip from sliding off the hang bar with a mid-section recess.

5. The hanging apparatus of claim 2, further comprising a spacer used with the flat hang bar to create a gap between the flat hang bar and the support surface.

6. The hanging apparatus of claim 1, wherein the hang clip has a clip hook to hang objects.

7. The hanging apparatus of claim 1, wherein the cross section of the hang bar and the cross section of the aperture of the hang clip have a rectangular shape.

8. The hanging apparatus of claim 7, wherein the rectangular cross section of the hang bar has a width W1 and the rectangular cross section of the aperture of the hang clip has a width W2, and W2 is greater than W1.

9. The hanging apparatus of claim 6, wherein the cross section of the hang bar and the cross section of the aperture of the hang clip comprise one of a J shape, a U shape, a square shape, a circular shape and a triangular shape.

10. The hanging apparatus of claim 1, wherein the support surface is a vertically oriented wall of a toolbox.

11. A toolbox with external storage, comprising:
a vertically oriented wall of the toolbox;
a hang bar having a mounting zone and hanging zone, the hanging zone usable to couple with a hang clip, the hang clip having an aperture with a cross section that matches a cross section of the hang bar, wherein the hang clip allows externally hanging tools and other objects from the toolbox.

12. The toolbox of claim 11, further comprising a recessed section in the vertically oriented wall of the toolbox.

13. The toolbox of claim 12, wherein the recessed section in the vertically oriented wall creates a gap between the hang bar and the recessed section to allow coupling the hang clip on the hanging zone of the hang bar.

14. The toolbox of claim 13, wherein the hang bar is attached to the vertically oriented wall outside boundaries of the recessed section.

15. The toolbox of claim 11, wherein the cross section of the hang bar is rectangular with a width W1 and the cross section of the aperture of the hang clip is rectangular with a width W2, and wherein W2 is greater than W1.

16. The toolbox of claim 11, wherein the cross section of the hang bar and the cross section of the aperture of the hang clip comprise one of a J shape, a U shape, a square shape, a circular shape and a triangular shape.

17. A method of mounting an item on a support surface, the method comprising:
nestably mounting a hang clip onto a hang bar having a first cross sectional area, the hang clip having an aperture and a clip hook protruding from the hang clip, wherein the aperture has a second cross sectional area that is matched to the first cross sectional area with respect to size and shape; and
mounting an item on the clip hook.

18. The method of claim 18, wherein the hang bar is mounted on a vertically oriented wall of a toolbox.

19. The method of claim 18, wherein the hang bar is flat and attached across a recessed surface of the vertically oriented wall of the toolbox.

20. The method of claim 18, wherein the hang bar has a bent arms on each of two ends of the hang bar and is used to attach the hang bar to sidewalls of the toolbox.
